(19) United States
(12) Patent Application Publication
(10) Pub. No.: US 2025/0371493 A1
(43) Pub. Date: Dec. 4, 2025

(54) Inventory quantity calculation system for estimating inventory quantities

(71) Applicant: InnoLux Corporation, Miao-Li County (TW)

(72) Inventors: Kuo-Chang CHEN, Miao-Li County (TW); Yi-Wen Chu, Miao-Li County (TW); Yi-Cheng Chang, Miao-Li County (TW); Po-Jui Weng, Miao-Li County (TW)

(73) Assignee: InnoLux Corporation, Miao-Li County (TW)

(21) Appl. No.: 19/200,718

(22) Filed: May 7, 2025

(30) Foreign Application Priority Data
Jun. 3, 2024 (CN) 202410705465.0

(51) Int. Cl. G06Q 10/087

(52) U.S. Cl. CPC G06Q 10/087

(57) ABSTRACT

An inventory quantity calculation system includes a receiving unit, a calculation unit, and an output unit. The receiving unit receives historical beginning-of-period stock quantity estimates, historical end-of-period stock quantity estimates, historical end-of-period actual stock quantities, and historical estimated shipment quantities. Based on the received historical beginning-of-period stock quantity estimates, historical end-of-period stock quantity estimates, historical end-of-period actual stock quantities, and historical estimated shipment quantities, the calculation unit determines a decision value and calculates a first stock quantity estimate and a second stock quantity estimate for the end of the next time period. The output unit outputs the first stock quantity estimate, the second stock quantity estimate, or a third stock quantity estimate based on the decision value. The third stock quantity estimate is calculated based on the first stock quantity estimate and the second stock quantity estimate.

### BACKGROUND OF THE DISCLOSURE

### 1. Field of the Disclosure

The disclosure involves an inventory quantity calculation system, specifically relating to a system for estimating inventory quantities through decision indicators, an Experience Model, and an Adaptive Weight Assignment Model.

### 2. Description of the Prior Art

The product life cycle of digital technology manufacturing industry is short, and its market status is prone to drastic changes. Therefore, it is crucial for enterprises to grasp and predict product inventory information. Traditional inventory estimation methods mainly rely on the experience of senior personnel, but this method has the following limitations: (a) high subjectivity: different personnel have different experiences, opinions, and estimation methods, leading to inaccurate inventory estimation results; (b) time-consuming and labor-intensive: manual calculation of inventory age requires a lot of time and effort; and (c) difficult to scale: as the number of products and number of production sites increase, the difficulty of manual inventory calculation increases exponentially.

### SUMMARY OF THE DISCLOSURE

According to some embodiments, the disclosure presents an inventory quantity calculation system configured to calculate stock quantity estimates at an end of a next time period. The inventory quantity calculation system comprises a receiving unit, a calculation unit, and an output unit. The receiving unit is configured to receive a plurality of historical beginning-of-period stock quantity estimates, a plurality of historical end-of-period stock quantity estimates, a plurality of historical end-of-period actual stock quantities, and a plurality of historical estimated shipment quantities. The calculation unit is configured to calculate a decision value, a first stock quantity estimate at the end of the next time period, and a second stock quantity estimate at the end of the next time period based on the plurality of historical beginning-of-period stock quantity estimates, the plurality of historical end-of-period stock quantity estimates, the plurality of historical end-of-period actual stock quantities, and the plurality of historical estimated shipment quantities. The output unit is configured to output at least one of the first stock quantity estimate, the second stock quantity estimate, and a third stock quantity estimate based on the decision value, wherein the third stock quantity estimate is calculated based on the first stock quantity estimate and the second stock quantity estimate.

According to some embodiments, the disclosure presents an inventory quantity calculation system configured to calculate stock quantity estimates at an end of a next time period. The inventory quantity calculation system comprises a receiving unit, a calculation unit, and an output unit. The receiving unit is configured to receive a plurality of historical beginning-of-period stock quantity estimates, a plurality of historical end-of-period stock quantity estimates, a plurality of historical end-of-period actual stock quantities, and a plurality of historical estimated shipment quantities. The calculation unit is configured to calculate a decision value, a first stock quantity estimate at the end of the next time period, and a second stock quantity estimate at the end of the next time period based on the plurality of historical beginning-of-period stock quantity estimates, the plurality of historical end-of-period stock quantity estimates, the plurality of historical end-of-period actual stock quantities, and the plurality of historical estimated shipment quantities. The output unit is configured to output at least one of the first stock quantity estimate, the second stock quantity estimate, and a third stock quantity estimate to a display unit based on the decision value, wherein the third stock quantity estimate is calculated based on the first stock quantity estimate and the second stock quantity estimate. The display unit displays the at least one of the first stock quantity estimate, the second stock quantity estimate, and the third stock quantity estimate outputted from the output unit.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 is a functional block diagram of an inventory quantity calculation system, according to one embodiment of the present disclosure, connected to a cloud system.

FIG. 2 is a flowchart of the inventory quantity calculation system from FIG. 1 for calculating stock quantity estimates.

FIG. 3 is a flowchart showing the calculation unit of the inventory quantity calculation system in FIG. 1 utilizing the Adaptive Weight Assignment Model to calculate the second stock quantity estimate.

FIG. 4 is another flowchart showing the calculation unit of the inventory quantity calculation system in FIG. 1 utilizing the Adaptive Weight Assignment Model to calculate the second stock quantity estimate.

### DETAILED DESCRIPTION

By referring to the following detailed description in conjunction with the accompanying drawings, the present disclosure can be understood. It should be noted that, for the sake of simplicity and to facilitate reader understanding, several drawings in the disclosure depict only parts of an electronic device, and specific components in the drawings are not drawn to scale. Additionally, the quantity and size of components in the figures are merely illustrative and should not be construed as limiting the scope of the disclosure.

Certain terms are used throughout the specification and the appended claims to refer to particular components. One of ordinary skill in the art should understand that manufacturers of electronic devices may refer to the same component by different names. This document does not intend to distinguish between components that differ in name but not in function.

In the specification and claims of the disclosure, the terms “including,” “comprising,” and “having” are open-ended terms, meaning that they are to be interpreted as “including, but not limited to . . . ”. Thus, when the disclosure describes something as “including,” “comprising,” and/or “having,” it signifies the presence of the stated features, regions, steps, operations, and/or components, but does not preclude the presence or addition of one or more other features, regions, steps, operations, and/or components.

Directional terms mentioned herein, such as “upper,” “lower,” “front,” “rear,” “left,” and “right,” are based on the orientation shown in the figures. Accordingly, the directional terms are used for explanatory purposes and not to limit the disclosure. The drawings depict typical features of the methods, structures, and/or materials used in specific embodiments. However, these figures should not be interpreted as defining or limiting the scope or nature of the embodiments covered. For instance, for clarity, the relative dimensions, thickness, and positions of layers, regions, and/or structures may be reduced or enlarged.

When a component (e.g., a layer or region) is referred to as being “on another component,” it can be directly on the other component or there may be intervening components. Conversely, when a component is referred to as being “directly on another component,” there are no intervening components. Additionally, when a component is described as being “on another component,” the components are in a vertical relationship, which means the component can be above or below the other component, depending on the device's orientation.

It should be understood that when a component or layer is referred to as “connected to” another component or layer, it can be directly connected to the other component or layer, or there may be intervening components or layers. When a component is referred to as being “directly connected to” another component or layer, there are no intervening components or layers. Furthermore, when a component is referred to as “coupled to another component (or its variant),” it can be directly electrically connected to the other component, or indirectly connected (e.g., indirectly electrically connected) through one or more intervening components.

In the disclosure, when a component is described as being “disconnected” from another component, electrical signals cannot flow between the two components during the specified time period.

The term “approximately” or “about” is generally interpreted as being within ±10% of the given value or within ±5%, ±3%, ±2%, ±1%, or ±0.5% of the given value.

The ordinal numbers used in the specification and patent claims, such as “first,” “second,” etc., are used to modify components and do not inherently indicate any order. They do not imply any sequence or manufacturing order but are used merely to distinguish components with similar names. It should be understood that the same terms used in the specification may not necessarily be used in the claims; hence, a component described as the first component in the specification might be the second component in the claims.

It should be noted that the features of various embodiments described below can be replaced, reorganized, or mixed without departing from the spirit of the disclosure to form other embodiments. Features among the embodiments can be combined as long as they do not contradict or conflict with the inventive concept.

In the disclosure, the electronic device may include a display device, a light-emitting device, an antenna device, a sensing device, a splicing device, or any combination thereof, but is not limited thereto. The display device may be a non-self-emissive display or a self-emissive display as needed, and it can be a color display or a monochrome display as required. The antenna device may be a liquid crystal antenna device or a non-liquid crystal antenna device; the sensing device may be a device that senses capacitance, light, heat, or ultrasonic waves; the splicing device may be a display splicing device or an antenna splicing device, but is not limited to these. The electronic device may include electronic components, which can include passive components and active components such as capacitors, resistors, inductors, diodes, and transistors. The diodes may include light-emitting diodes (LEDs) or photodiodes. The light-emitting diodes may include organic light-emitting diodes (OLEDs), mini LEDs, micro LEDs, or quantum dot LEDs, but are not limited to these. The transistors may include top-gate thin-film transistors, bottom-gate thin-film transistors, or dual-gate thin-film transistors, but are not limited to these. The electronic device may also include fluorescent materials, phosphor materials, quantum dot (QD) materials, or other suitable materials as required, but is not limited to these. The electronic device can have peripheral systems such as a driving system, a control system, a light source system, and so on, to support the devices and components within the electronic device.

It should be noted that the technical features described in the various embodiments below can be replaced, reorganized, or combined with each other without departing from the spirit of the disclosure to form other embodiments.

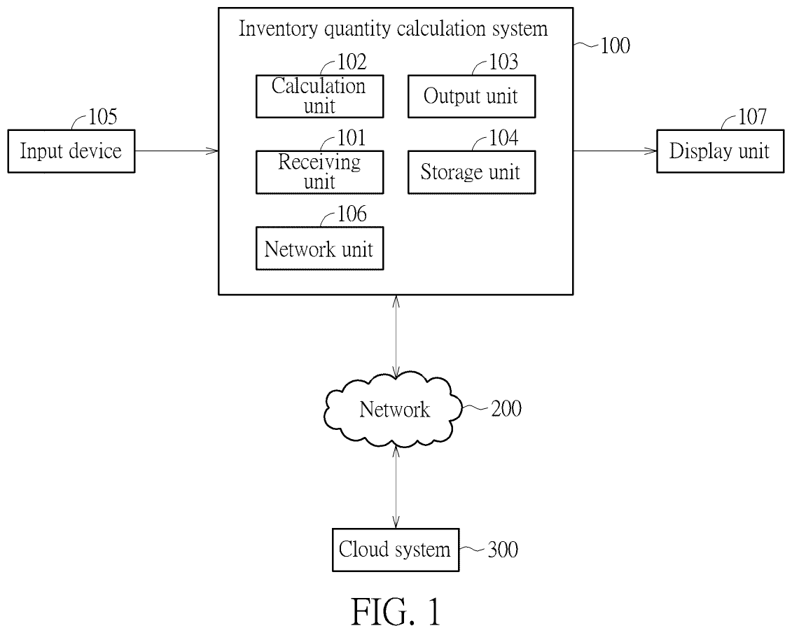

Please refer to FIG. 1. FIG. 1 is a functional block diagram of an inventory quantity calculation system 100 in one embodiment of the disclosure, which can be linked to a cloud system 300 through a network 200. The inventory quantity calculation system 100 is used to calculate the stock quantity estimates at the end of each time period. For example, the time period could be “one month,” but the disclosure is not limited to this. In other embodiments of the disclosure, a time period could be “one day,” “one week (i.e., seven days),” “three months,” “six months,” or other durations. For example, the inventory quantity calculation system 100 can be used in the current month to calculate the stock quantity estimate at the end of the next month. For instance, assuming today is April 10, the inventory quantity calculation system 100 can calculate the stock quantity estimate for a specific item as of May 31 of this year. The inventory quantity calculation system 100 may comprise a receiving unit 101, a calculation unit 102, and an output unit 103. The receiving unit 101 is used to receive inventory data values, the calculation unit 102 calculates the stock quantity estimate based on the inventory data values received by the receiving unit 101, and the output unit 103 is used to output the stock quantity estimate calculated by the calculation unit 102. The receiving unit 101 can include, but is not limited to, a Universal Serial Bus (USB) or Peripheral Component Interconnect Express (PCI-E). The calculation unit 102 can include, but is not limited to, a Central Processing Unit (CPU), but the disclosure is not limited to this. The output unit 103 can include, but is not limited to, a USB, PCI-E, video card interfaces (e.g., VGA, DVI, HDMI interfaces, or DisplayPort interfaces), and printer interfaces.

In one embodiment of the disclosure, the inventory quantity calculation system 100 may also comprise a storage unit 104 to store the inventory data values received by the receiving unit 101, the programs and/or data values needed by the calculation unit 102 during the calculation process, and/or the stock quantity estimates to be output by the output unit 103, but the disclosure is not limited to these. The storage unit 104 can include, but is not limited to, dynamic random-access memory, static random-access memory, flash memory, floppy disks, hard disks, optical disks, USB drives, tapes, or combinations of these, but the disclosure is not limited to these. In one embodiment, the calculation unit 102 can access and execute the programs stored in the storage unit 104 to achieve the functions intended by the inventory quantity calculation system 100.

In one embodiment of the disclosure, the inventory quantity calculation system 100 may also comprise a network unit 106, which connects to a cloud system 300 through the network 200. The network 200 may be a local area network or the Internet. The cloud system 300 may be a server or another inventory quantity calculation system 100. In one embodiment, the receiving unit 101 can be coupled to the cloud system 300 through the network unit 106 and the network 200 to receive the inventory data values required by the calculation unit 102.

In one embodiment of the disclosure, the inventory quantity calculation system 100 can be coupled to an input device 105. The input device 105 allows a user of the inventory quantity calculation system 100 to input data values and/or commands, enabling the inventory quantity calculation system 100 to perform corresponding operations based on the data values and/or commands input by the user through the input device 105. The input device 105 can include, but is not limited to, a keyboard, mouse, or barcode scanner.

In one embodiment of the disclosure, the inventory quantity calculation system 100 can be coupled to a display unit 107. The display unit 107 is used to display the stock quantity estimate calculated by the calculation unit 102. The display unit 107 can be a non-self-emissive display or a self-emissive display, and it can be a color display or a monochrome display as needed.

The inventory quantity calculation system 100 is a mixed model calculation system that incorporates strategic thinking. It can utilize decision indicator values (e.g., Relative Strength Index (RSI), Stochastic Oscillator (also known as KD indicator), Moving Average Convergence/Divergence (MACD)) to assist the model in interpreting inventory trends and assign weights over different time periods for estimation. However, the disclosure is not limited to this. The mixed strategy model of the inventory quantity calculation system 100 includes the Experience Model and the Adaptive Weight Assignment Model. The Experience Model is a method that combines domain expert knowledge and experience, converting it into a digital twin. The Adaptive Weight Assignment Model integrates past historical data values and expert experience to assign adaptive weights to different strategies. The inventory quantity calculation system 100 uses the aforementioned decision indicators, Experience Model, and Adaptive Weight Assignment Model to perform inventory estimation, estimate the inventory age of semi-finished products, control product quality, and optimize inventory management strategies across different factories. This enables flexibility and agility in the supply chain, production activities, and sales end, thereby enhancing corporate competitiveness.

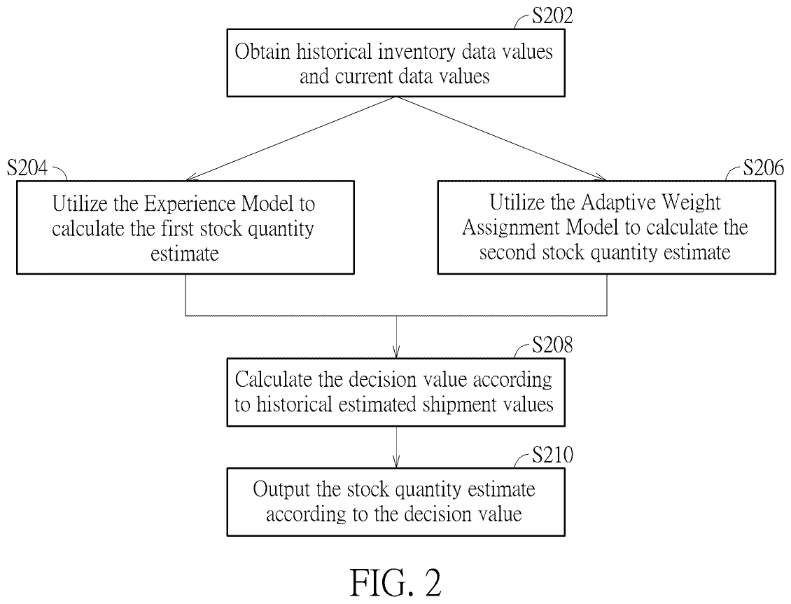

Please refer to FIG. 2. FIG. 2 is a flowchart of the inventory quantity calculation system 100 in FIG. 1 for calculating a stock quantity estimate. In step S202, the calculation unit 102, through the receiving unit 101, obtains historical inventory data values and current data values. The historical inventory data values may comprise a plurality of historical beginning-of-period stock quantity estimates, a plurality of historical end-of-period stock quantity estimates, a plurality of historical end-of-period actual stock quantities, and a plurality of historical estimated shipment quantities. The acquired current data values may comprise shipment plans, bills of materials (BoM), cycle times (CT), and inventory quantities. The historical inventory data values and/or current data values can be stored in the cloud system 300, but this is not limited to this. The plurality of historical beginning-of-period stock quantity estimates may be, for example, the stock quantity estimates at the beginning of the previous month and the month before last (assuming today is April 10, the beginning-of-period stock quantity estimate for the previous month would be the estimate for March 1, and the beginning-of-period stock quantity estimate for the month before last would be the estimate for February 1). The plurality of historical end-of-period stock quantity estimates may be, for example, the stock quantity estimates at the end of the previous month and the month before last (assuming this year is a leap year and today is April 10, the end-of-period stock quantity estimate for the previous month would be the estimate for March 31, and the end-of-period stock quantity estimate for the month before last would be the estimate for February 29). The plurality of historical end-of-period actual stock quantities may comprise, for example, the actual stock quantities at the end of the previous month and the month before last, which is the actual quantity stored in the warehouse (assuming this year is a leap year and today is April 10, the actual stock quantity at the end of the previous month would be the actual quantity as of March 31, and the actual stock quantity at the end of the month before last would be the actual quantity as of February 29). The plurality of historical estimated shipment quantities may comprise, for example, the estimated shipment values for the previous month and the month before last, which can be calculated by the calculation unit 102 based on the shipment plans, bills of materials (BoM), and cycle times (CT) for each month. The shipment plan information refers to the number of shipments planned for the future, the bill of materials is a list of product part numbers, and the cycle time table is the production time for each product part number. Combining the bill of materials and cycle time can also yield related shipment information. In step S204, the calculation unit 102 uses the data values obtained in step S202 and employs the Experience Model to calculate the first stock quantity estimate. The concept of the Experience Model used by the calculation unit 102 is as follows: Let the inventory for the day be Sₜ and the corresponding outbound quantity be PLₜ, where PLₜ is the quantity of inventory items leaving the warehouse. The outbound quantity PLₜ can be derived from many data values (e.g., current shipment plan, bill of materials, cycle time). To estimate the inventory for the next month (Pₜ) from the current time t, the following formula can be used:

$${P}_{t} = {S}_{t} - {PL}_{t}$$

Assuming today is November 23rd, to estimate the inventory at the end of next month (December 31st) using the Experience Model, the calculation unit 102 can calculate (S_{11/23}−PL_{11/23}) to obtain the stock quantity estimate P_{11/23} on December 31st. Here, S_{11/23} represents the current inventory on November 23rd, and PL_{11/23} represents the estimated outgoing quantity from November 23rd to December 31st calculated on November 23rd. Therefore, P_{11/23} is the estimated inventory quantity on December 31st for the calculation unit 102 using the Experience Model on November 23rd. The stock quantity estimate calculated by the calculation unit 102 using the Experience Model in step S204 can be referred to as the “first stock quantity estimate”.

In step S206, the calculation unit 102 utilizes the Adaptive Weight Assignment Model based on the data obtained in step S202 to calculate the second stock quantity estimate. The detailed process of how calculation unit 102 uses the Adaptive Weight Assignment Model to calculate the second stock quantity estimate will be elaborated in the following explanation.

The “first stock quantity estimate” obtained in step S204 and the “second stock quantity estimate” obtained in step S206 are estimated based on the “Experience Model” and the “Adaptive Weight Assignment Model,” respectively. Therefore, there may be differences between the first stock quantity estimate and the second stock quantity estimate. As described above, the Experience Model is a method that combines domain expert knowledge and experience and converts it into a digital twin. The Adaptive Weight Assignment Model integrates historical data and expert experience to assign adaptive weights to different strategies. Due to the potential differences between the first stock quantity estimate and the second stock quantity estimate, in step S208, the calculation unit 102 can calculate a decision value based on historical estimated shipment values. The purpose of the decision value is to measure and compare the feasibility of the first stock quantity estimate and the second stock quantity estimate. The calculation unit 102 can use the decision value to determine whether to adopt the first stock quantity estimate, the second stock quantity estimate, or another stock estimate. The decision value includes but is not limited to: Relative Strength Index (RSI), Stochastic Oscillator (KD indicator), Moving Average Convergence/Divergence (MACD), etc. The calculation unit 102 can use the decision value to apply a quantitative standard for the algorithm and establish different thresholds to understand the current market trend status. The threshold settings can be changed or adjusted based on different application fields. Further explanations on how the calculation unit 102 calculates the decision value and how the decision value is utilized will be provided in the following description.

In step S210, the calculation unit 102 determines and outputs the stock quantity estimate to the output unit 103 based on the decision value calculated in step S208 and the first stock quantity estimate and second stock quantity estimate calculated in steps S204 and S206, respectively. This allows the output unit 103 to present the received stock quantity estimate through the display unit 107 and/or store it in the storage unit 104.

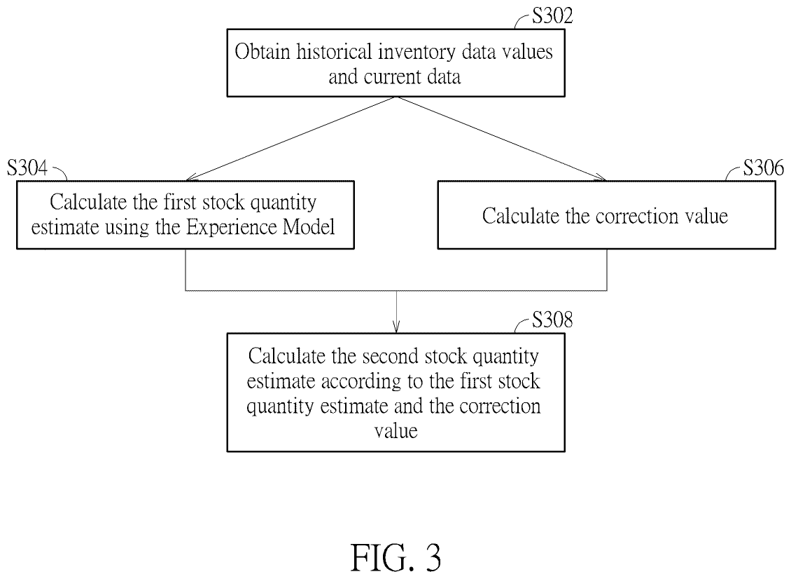

The following explains how the calculation unit 102 uses the Adaptive Weight Assignment Model to calculate the second stock quantity estimate. The Adaptive Weight Assignment Model is an extension based on the Experience Model. It utilizes the ratio between the actual stock value at the end of a historical future time period (e.g., the end of next month for the current month) and the stock quantity estimate from the Experience Model at the beginning of the historical time period (e.g., the beginning of the current month). It also uses the ratio between the actual stock value at the end of a historical future time period (e.g., the end of next month for the current month) and the stock quantity estimate from the Experience Model at the end of the historical time period (e.g., the end of the current month). By applying harmonic mean, arithmetic mean, or geometric mean, it calculates the average ratios for the beginning and the end of the historical time period. These averages are then used to calculate the corresponding correction value through interpolation. The correction value is multiplied by the current stock quantity estimate to obtain the final stock quantity estimate for the current time. Please refer to FIG. 3. FIG. 3 is a flowchart showing how the calculation unit 102 of the inventory quantity calculation system 100 in FIG. 1 calculates the second stock quantity estimate using the Adaptive Weight Assignment Model. In step S302, the calculation unit 102 obtains historical inventory data values and current data values through the receiving unit 101. The historical inventory data values and current data values obtained are as previously described and will not be repeated here. In step S304, the calculation unit 102 calculates the first stock quantity estimate using the Experience Model as described above. In step S306, the calculation unit 102 calculates the correction value based on the plurality of historical beginning-of-period stock quantity estimates, historical end-of-period stock quantity estimates, and historical end-of-period actual stock quantities. In step S308, the calculation unit 102 calculates the second stock quantity estimate based on the first stock quantity estimate and the correction value. An example to illustrate this will be provided below.

Assuming today is November 23rd, to estimate the inventory at the end of next month (December 31st), the calculation unit 102 can utilize the inventory information from the end of May (May 31st) to the end of October (October 31st) to obtain a correction value. In step S304, the calculation unit 102, based on the aforementioned method, utilizes the Experience Model to calculate the estimated inventory quantity P_{11/23} on December 31st as of November 23rd. In addition, assuming that P_{begin} represents the estimated inventory quantity at the beginning of each month and P_{end} represents the estimated inventory quantity at the end of each month, and A_{next_end} represents the actual inventory quantity at the end of the next month. The ratio between the actual inventory quantity at the end of the next month and the estimated inventory quantity at the beginning of the current month is denoted as R_{begin}, While the ratio between the actual inventory quantity at the end of the next month and the estimated inventory quantity at the end of the current month is denoted as R_{end}.

For June:
P_{begin}=P_{06/01}=(The stock quantity estimate at the beginning of June (i.e., June 1) based on the Experience Model);
P_{end}=P_{06/30}=(The stock quantity estimate at the end of June (i.e., June 30) based on the Experience Model);
A_{next_end}=A_{07/31}=(The actual stock quantity at the end of July (i.e., July 31));

$${R}_{begin} = {R}_{06 / 01} = \frac{{A}_{07 / 31}}{{P}_{06 / 01}} ; and {R}_{end} = {R}_{06 / 30} = \frac{{A}_{07 / 31}}{{P}_{06 / 30}} .$$

For July:
P_{begin}=P_{07/01}=(The stock quantity estimate at the beginning of July (i.e., July 1) based on the Experience Model);
P_{end}=P_{07/31}=(The stock quantity estimate at the end of July (i.e., July 31) based on the Experience Model);
A_{next_end}=A_{08/31}=(The actual stock quantity at the end of August (i.e., August 31));

$${R}_{begin} = {R}_{07 / 01} = \frac{{A}_{08 / 31}}{{P}_{07 / 01}} ; and {R}_{end} = {R}_{07 / 31} = \frac{{A}_{08 / 31}}{{P}_{07 / 31}} .$$

For August:
P_{begin}=P_{08/01}=(The stock quantity estimate at the beginning of August (i.e., August 1) based on the Experience Model);
P_{end}=P_{08/31}=(The stock quantity estimate at the end of August (i.e., August 31) based on the Experience Model);
A_{next_end}=A_{09/30}=(The actual stock quantity at the end of September (i.e., September 30));

$${R}_{begin} = {R}_{08 / 01} = \frac{{A}_{09 / 30}}{{P}_{08 / 01}} ; and {R}_{end} = {R}_{08 / 31} = \frac{{A}_{09 / 30}}{{P}_{08 / 31}} .$$

For September:
P_{begin}=P_{09/01}=(The stock quantity estimate at the beginning of September (i.e., September 1) based on the Experience Model);
P_{end}=P_{09/30}=(The stock quantity estimate at the end of September (i.e., September 30) based on the Experience Model);
A_{next_end}=A_{10/31}=(The actual stock quantity at the end of October (i.e., October 31));

$${R}_{begin} = {R}_{09 / 01} = \frac{{A}_{10 / 31}}{{P}_{09 / 01}} ; and {R}_{end} = {R}_{09 / 30} = \frac{{A}_{10 / 31}}{{P}_{09 / 30}} .$$

P_{06/01}, P_{06/30}, P_{07/01}, P_{07/31}, P_{08/01}, P_{08/31}, P_{09/01}, and P_{09/30} are the first stock quantity estimates obtained on June 1st, June 30th, July 1st, July 31st, August 1st, August 31st, September 1st, and September 30th, respectively, through the aforementioned Experience Model. These estimates can be calculated in advance by the calculation unit 102 and then retrieved by the receiving unit 101. A_{07/31}, A_{08/31}, A_{09/30}, and A_{10/31} represent the actual stock quantities on July 31st, August 31st, September 30th, and October 31st, respectively.

In step S306, the calculation unit 102 can calculate the average of the beginning-of-month inventory ratio G_{begin} and the average of the end-of-month inventory ratio G_{end} using one of the following methods: harmonic mean, arithmetic mean, or geometric mean. For example, using the geometric mean,

$${G}_{begin} = \sqrt[4]{{R}_{06 / 01} \times {R}_{07 / 01} \times {R}_{08 / 01} \times {R}_{09 / 01}} , \\ and {G}_{end} \sqrt[4]{{R}_{06 / 30} \times {R}_{07 / 31} \times {R}_{08 / 31} \times {R}_{09 / 30}} .$$

The calculation unit 102 then calculates the correction value G_{today} using the method of interpolation. Assuming today is November 23rd, the correction value

$${G}_{today} = \frac{7}{22 + 7} \times {G}_{begin} + \frac{22}{22 + 7} \times {G}_{end} .$$

There are 22 days between November 1 and November 23, and 7 days between November 23 and November 30. Therefore, using interpolation, G_{begin} multiplied by

$$\frac{7}{22 + 7}$$

plus G_{end} multiplied by

$$\frac{22}{22 + 7}$$

equals the correction value G_{today}.

In step S308, the calculation unit 102 multiplies P_{11/23} by the correction value G_{today} to obtain the stock quantity estimate for the end of December based on the Adaptive Weight Assignment Model. Therefore, the stock quantity estimate at the end of December=(G_{today}×P_{11/23}).

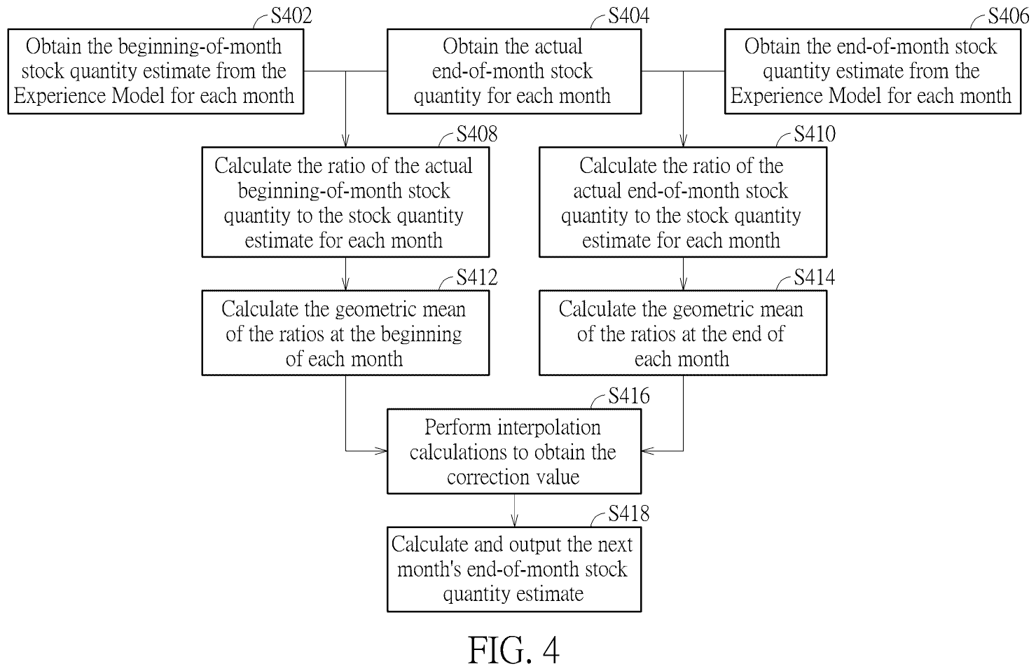

Please refer to FIG. 4. FIG. 4 is another flowchart showing how the calculation unit 102 of the inventory quantity calculation system 100 in FIG. 1 calculates the second stock quantity estimate using the Adaptive Weight Assignment Model. The flow in FIG. 4 corresponds to the description of the flow in FIG. 3. In step S402, the calculation unit 102, through the receiving unit 101, obtains the beginning-of-month stock quantity estimate from the Experience Model for each month (e.g., the aforementioned P_{06/01}, P_{07/01}, P_{08/01}, and P_{09/01}. In step S404, the calculation unit 102, through the receiving unit 101, obtains the actual end-of-month stock quantity for each month (e.g., the aforementioned A_{07/31}, A_{08/31}, A_{09/30}, and A_{10/31}). In step S406, the calculation unit 102, through the receiving unit 101, obtains the end-of-month stock quantity estimate from the Experience Model for each month (e.g., the aforementioned P_{06/30}, P_{07/31}, P_{08/31}, and P_{09/30}. In step S408, the calculation unit 102 calculates the ratio of the actual beginning-of-month stock quantity to the stock quantity estimate for each month (e.g., the aforementioned R_{06/01}, R_{07/01}, R_{08/01}, and R_{09/01}). In step S410, the calculation unit 102 calculates the ratio of the actual end-of-month stock quantity to the stock quantity estimate for each month (e.g., the aforementioned R_{06/30}, R_{07/31}, R_{08/31}, and R_{09/30}. In step S412, the calculation unit 102 calculates the geometric mean of the ratios at the beginning of each month (e.g., the aforementioned

$$\sqrt[4]{{R}_{06 / 01} \times {R}_{07 / 01} \times {R}_{08 / 01} \times {R}_{09 / 01}} .$$

In step S414, the calculation unit 102 calculates the geometric mean of the ratios at the end of each month (e. g., the aforementioned

$$\sqrt[4]{{R}_{06 / 30} \times {R}_{07 / 31} \times {R}_{08 / 31} \times {R}_{09 / 30}} .$$

In step S416, the calculation unit 102 performs interpolation calculations to obtain the correction value (e.g., the aforementioned G_{today}). In step S418, the calculation unit 102 calculates and outputs the next month's end-of-month stock quantity estimate (e.g., (the aforementioned stock quantity estimate at the end of December)=(G_{today}×P_{11/23}).

In the above embodiment, the Adaptive Weight Assignment Model is primarily used to estimate the stock quantity estimate at the end of the next month. In other embodiments of the disclosure, the calculation unit 102 can use the Adaptive Weight Assignment Model to estimate the stock quantity at the end of the next two months. For example, assuming today is November 23, the calculation unit 102 can estimate the stock quantity at the end of January of the next year (i.e., January 31 of the following year). Since the estimate is for the end of the next two months, the actual stock quantity used in the ratio calculations will be the actual stock quantity at the end of the next two months. For June,

$${R}_{begin} = {R}_{06 / 01} = \frac{{A}_{08 / 31}}{{p}_{06 / 01}} , and {R}_{end} = {R}_{06 / 30} = \frac{{A}_{08 / 31}}{{P}_{06 / 30}} .$$

### For July,

$${R}_{begin} = {R}_{07 / 01} = \frac{{A}_{09 / 30}}{{P}_{07 / 01}} , and {R}_{end} = {R}_{07 / 31} = \frac{{A}_{09 / 30}}{{P}_{07 / 31}} .$$

### For August,

$${R}_{begin} = {R}_{08 / 01} = \frac{{A}_{10 / 31}}{{p}_{08 / 01}} , and {R}_{end} = {R}_{08 / 31} = \frac{{A}_{10 / 31}}{{p}_{08 / 31}} .$$

In step S306 of the present embodiment, the calculation unit 102 calculates the average value G_{begin} of the beginning-of-month inventory ratio and the average value G_{end} of the end-of-month inventory ratio, respectively, using the harmonic mean, arithmetic mean, or geometric mean. For example, using the geometric mean,

$${G}_{begin} = \sqrt[3]{{R}_{06 / 01} \times {R}_{07 / 01} \times {R}_{08 / 01}} , and {G}_{end} = \sqrt[3]{{R}_{06 / 30} \times {R}_{07 / 31} \times {R}_{08 / 31}}$$

Subsequently, the calculation unit 102 calculates the correction value G_{today} using interpolation. Assuming today is November 23, the correction value

$${G}_{today} = ( \frac{7}{22 + 7} \times {G}_{begin} + \frac{22}{22 + 7} \times {G}_{end} ) .$$

Since November 23 is 22 days away from November 1 and 7 days away from November 30, the correction value G_{today} is calculated by multiplying G_{begin} by

$$\frac{7}{22 + 7}$$

and adding it to the product of G_{end} and

$$\frac{22}{22 + 7} .$$

In step S308 of the present embodiment, the calculation unit 102 multiplies P_{11/23} by the correction value G_{today} to obtain the estimated stock quantity for the end of January of the next year based on the “Adaptive Weight Assignment Model”, i.e., the estimated stock quantity for the end of January of the next year=(G_{today}×P_{11/23}).

The following explains how the calculation unit 102 calculates the decision value and how it utilizes this decision value. As mentioned earlier, the purpose of the decision value is to measure and compare the feasibility of the first stock quantity estimate, the second stock quantity estimate, or a third stock quantity estimate derived from the first stock quantity estimate and second stock quantity estimate. The calculation unit 102 can use the decision value as a measure to adopt the first stock quantity estimate, the second stock quantity estimate, or the third stock quantity estimate. The decision value includes, but is not limited to, the following: Relative Strength Index (RSI) of a plurality of historical estimated shipment quantities, Stochastic Oscillator values of a plurality of historical estimated shipment quantities, and Moving Average Convergence/Divergence (MACD) values of a plurality of historical estimated shipment quantities. The calculation unit 102 uses the decision value as a quantitative standard for applying algorithms and establishes different thresholds to understand the current market trend. The threshold settings can be changed based on different application fields. After obtaining the estimated inventory values at various time points within a time period (e.g., a month), if the RSI indicator is used to determine the market trend, the calculation unit can calculate the market's rising or falling magnitude during that period. By taking the average of the market's rise and fall magnitudes, the RSI value can be obtained. This value is then used with different thresholds to judge the current market trend of the estimated inventory values. Here is an example:

The Relative Strength Index (RSI) is calculated as follows:

$$R S I = \frac{R}{R + D} \times 100$$

where R is the average gain within the time period, and D is the average loss within the time period. Assuming the estimated shipment quantities for the shipping plans on 06/23, 07/23, 08/23, 09/23, 10/23, and 11/23 of the year 2023 are available, as shown in Table 1 below:

TABLE 1

| | Date | | | | | |
|---|---|---|---|---|---|---|
| | June | July | August | September | October | November |
| | 2023 | 2023 | 2023 | 2023 | 2023 | 2023 |
| Shipment | 2295 | 2275 | 2300 | 2365 | 2340 | 2320 |
| Quantity | | | | | | |

The values for R, D, and RSI based on the shipment quantities can be calculated as follows:

$$R = \frac{( 2 \; 300 - 2275 ) + ( 2 \; 365 - 2300 )}{2} = 45$$

$$D = \frac{\vert 2275 - 2295 \vert + \vert 2340 - 2365 \vert + \vert 2320 - 2340 \vert}{3} = 21.67$$

$$R S I = \frac{R}{R + D} \times 100 = \frac{45}{45 + 21.67} \times 100 = 67.50$$

In this embodiment, when the calculation unit 102 executes step S210 in FIG. 2, it will refer to Table 2 to determine the market trend based on the range of the Relative Strength Index (RSI) and select an appropriate model to estimate the stock quantity.

TABLE 2

| RSI | Trend Judgment | Selected Model |
|---|---|---|
| RSI < 20 | Trend declining to reversal | Experience Model |
| | point, about to rise | |
| 20 ≤ RSI ≤ 40 | Trend declining | Mixed model |
| 40 < RSI < 60 | Close to past trend | Adaptive Weight |
| | | Assignment Model |
| 60 ≤ RSI ≤ 80 | Trend rising | Mixed model |
| RSI > 80 | Trend rising to reversal | Experience Model |
| | point, about to fall | |

When the Relative Strength Index (RSI) is less than 20 or greater than 80, the calculation unit 102 selects the first stock quantity estimate, estimated using the Experience Model, as the final output stock quantity estimate. When the RSI is between 40 and 60, the calculation unit 102 selects the second stock quantity estimate, estimated using the Adaptive Weight Assignment Model, as the final output stock quantity estimate. When the RSI is between 20 and 40 (20≤RSI≤40) or between 60 and 80 (60≤RSI≤80), the calculation unit 102 selects the third stock quantity estimate, estimated using the mixed model, as the final output stock quantity estimate, which can be displayed through the display unit 107. Further explanation on the mixed model will be provided below.

The following explains how the calculation unit 102 uses the mixed model to estimate the stock quantity to obtain the third stock quantity estimate. The mixed model is a combination of the Experience Model and the Adaptive Weight Assignment Model. The stock quantity estimated by the calculation unit 102 using the mixed model can be referred to as the “third stock quantity estimate,” and the third stock quantity estimate is obtained by the calculation unit 102 through interpolation of the first stock quantity estimate and the second stock quantity estimate.

Assuming today is November 23, to predict the inventory at the end of next month (December 31), the first stock quantity estimate for December 31 using the Experience Model is denoted as \hat{P}₁, and the second stock quantity estimate for December 31 using the Adaptive Weight Assignment Model is denoted as \hat{P}₂. The calculated RSI value is denoted as x. If (20≤x≤40), then the predicted stock quantity for the end of December is

$$( \frac{x - 20}{20} * {\hat{P}}_{2} + \frac{40 - x}{20} * {\hat{P}}_{1} ) ,$$

which is considered the third stock quantity estimate when (20≤x≤40). If (60≤x≤80), then the predicted stock quantity for the end of December is

$$( \frac{80 - x}{20} * {\hat{P}}_{2} + \frac{x - 60}{20} * {\hat{P}}_{1} ) ,$$

which is considered the third stock quantity estimate when (60≤x≤80).

Similarly, when the decision value is the Stochastic Oscillator (also known as the KD indicator), the market trend can be judged based on the range of the D value in the Stochastic Oscillator, as shown in Table 3, and the appropriate model can be selected to estimate the stock quantity.

TABLE 3

| KD | Trend Judgment | Selected Model |
|---|---|---|
| D < 20 | Trend declining to reversal | Experience Model |
| | point, about to rise | |
| 20 ≤ D < 50 | Trend declining | Mixed model |
| D = 50 | Close to past trend | Adaptive Weight |
| | | Assignment Model |
| 50 < D ≤ 80 | Trend rising | Mixed model |
| D > 50 | Trend rising to reversal | Experience Model |
| | point, about to fall | |

If the decision value is the Stochastic Oscillator (also known as the KD indicator), it can be calculated using the following three formulas:

$$RSV = \frac{Current month ’ s value - Lowest value in recent N months}{Highest value in recent N months - Lowest value in recent N months} \times 100$$

$$Current month ’ s K value = \frac{2}{3} \times Previous month ’ s K value + \frac{1}{3} \times Current month ’ s RSV$$

$$Current month ’ s D value = \frac{2}{3} \times Previous month ’ s D value + \frac{1}{3} \times Current month ’ s K value$$

Assuming today is November 23, to predict the inventory at the end of next month (December 31), the first stock quantity estimate for December 31 using the Experience Model is denoted as \hat{P}₁, and the second stock quantity estimate for December 31 using the Adaptive Weight Assignment Model is denoted as \hat{P}₂. The D value calculated from the KD indicator is denoted as D. If 20≤D<50, then

$$the stock quantity estimate at the end of December = ( \frac{D - 20}{30} * \hat{{P}_{2}} + \frac{50 - D}{30} * {\hat{P}}_{1} ) ,$$

which is considered the third stock quantity estimate when (20≤D<50). If 50<D≤80, then

$$the stock quantity estimate at the end of December = ( \frac{80 - D}{30} * \hat{{P}_{2}} + \frac{D - 50}{30} * {\hat{P}}_{1} ) ,$$

which is considered the third stock quantity estimate when (50<D≤80).

Similarly, when the decision value is the Moving Average Convergence Divergence (MACD) indicator, the market trend can be judged based on the MACD line and DIF slope, as shown in Table 4, and the appropriate model can be selected to estimate the stock quantity.

TABLE 4

| MACD | Trend Judgment | Selected Model |
|---|---|---|
| The slope of MACD is | The trend is about to | Experience Model |
| opposite to the slope | reverse, shifting | |
| of DIF | from a downward or | |
| | upward trajectory to | |
| | a turning point | |
| The slope of MACD is | Close to past trend | Adaptive Weight |
| the same as the slope | | Assignment Model |
| of DIF | | |
| MACD or DIF equals 0 | Close to past trend | Adaptive Weight |
| | | Assignment Model |

If the decision value is the Moving Average Convergence Divergence (MACD) indicator, it can be calculated using the following two formulas:

$$DIF = EMA ( M ) - EMA ( N )$$

$$MACD = EMA ( DIF , D )$$

where EMA(M) is the M-month exponential moving average, EMA(N) is the N-month exponential moving average, and N>M.

The disclosed inventory quantity calculation system incorporates a mixed model with a strategic mindset. It utilizes decision indicators (such as RSI, KD index, and MACD) to assist the model in judging inventory trends and assigning weights to different time periods for forecasting. By leveraging decision indicators, the Experience Model, and the Adaptive Weight Assignment Model, the inventory quantity calculation system can forecast inventory, manage product quality, and/or optimize inventory management strategies across different factories, thereby enhancing supply chain flexibility, production efficiency, and overall business competitiveness.

The present disclosure also provides a computer-readable storage medium having stored thereon a computer program. The computer program is configured to cause a computer to perform the method of calculating the stock quantity estimate as described above.

The present disclosure also provides a non-volatile computer-readable storage medium storing one or more program modules. When the one or more program modules are applied in a device, the device can execute instructions included in any one of the embodiments described above.

The computer-readable storage medium may be, but is not limited to, an electrical, magnetic, optical, electromagnetic, infrared, or semiconductor device or device, or any combination thereof. More specific examples of computer-readable storage media may include, but are not limited to, removable computer disks, hard disks, random access memory (RAM), read-only memory (ROM), erasable programmable read-only memory (EPROM), optical fiber, compact disc read-only memory (CD-ROM), optical storage devices, magnetic storage devices, or any suitable combination thereof.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. An inventory quantity calculation system for calculating stock quantity estimates at an end of a next time period, the inventory quantity calculation system comprising:
a receiving unit configured to receive a plurality of historical beginning-of-period stock quantity estimates, a plurality of historical end-of-period stock quantity estimates, a plurality of historical end-of-period actual stock quantities, and a plurality of historical estimated shipment quantities;
a calculation unit configured to calculate a decision value, a first stock quantity estimate at the end of the next time period, and a second stock quantity estimate at the end of the next time period based on the plurality of historical beginning-of-period stock quantity estimates, the plurality of historical end-of-period stock quantity estimates, the plurality of historical end-of-period actual stock quantities, and the plurality of historical estimated shipment quantities; and
an output unit configured to output at least one of the first stock quantity estimate, the second stock quantity estimate, and a third stock quantity estimate based on the decision value, wherein the third stock quantity estimate is calculated based on the first stock quantity estimate and the second stock quantity estimate.

2. The inventory quantity calculation system of claim 1, wherein the decision value is of a Relative Strength Index (RSI) of the plurality of historical estimated shipment quantities.

3. The inventory quantity calculation system of claim 1, wherein the decision value is of a stochastic oscillator (KD indicator) of the plurality of historical estimated shipment quantities.

4. The inventory quantity calculation system of claim 1, wherein the decision value is of a moving average convergence/divergence (MACD) indicator of the plurality of historical estimated shipment quantities.

5. The inventory quantity calculation system of claim 1, being coupled to a display unit, wherein the at least one of the first stock quantity estimate, the second stock quantity estimate, and the third stock quantity estimate is displayed on the display unit.

6. The inventory quantity calculation system of claim 1, wherein the plurality of historical beginning-of-period stock quantity estimates, the plurality of historical end-of-period stock quantity estimates, the plurality of historical end-of-period actual stock quantities, and the plurality of historical estimated shipment quantities are stored in a cloud system.

7. The inventory quantity calculation system of claim 6, further comprising a network unit, wherein the receiving unit receives the plurality of historical beginning-of-period stock quantity estimates, the plurality of historical end-of-period stock quantity estimates, the plurality of historical end-of-period actual stock quantities, and the plurality of historical estimated shipment quantities from the cloud system through the network unit.

8. The inventory quantity calculation system of claim 1, wherein the calculation unit calculates the first stock quantity estimate through an experience model.

9. The inventory quantity calculation system of claim 1, wherein the calculation unit calculates the second stock quantity estimate through an adaptive weight assignment model.

10. The inventory quantity calculation system of claim 1, wherein the third stock quantity estimate is obtained by interpolating the first stock quantity estimate and the second stock quantity estimate.

11. An inventory quantity calculation system for calculating stock quantity estimates at an end of a next time period, the inventory quantity calculation system comprising:
a receiving unit configured to receive a plurality of historical beginning-of-period stock quantity estimates, a plurality of historical end-of-period stock quantity estimates, a plurality of historical end-of-period actual stock quantities, and a plurality of historical estimated shipment quantities;
a calculation unit configured to calculate a decision value, a first stock quantity estimate at the end of the next time period, and a second stock quantity estimate at the end of the next time period based on the plurality of historical beginning-of-period stock quantity estimates, the plurality of historical end-of-period stock quantity estimates, the plurality of historical end-of-period actual stock quantities, and the plurality of historical estimated shipment quantities; and
an output unit configured to output at least one of the first stock quantity estimate, the second stock quantity estimate, and a third stock quantity estimate to a display unit based on the decision value, wherein the third stock quantity estimate is calculated based on the first stock quantity estimate and the second stock quantity estimate, and the display unit displays the at least one of the first stock quantity estimate, the second stock quantity estimate, and the third stock quantity estimate outputted from the output unit.

12. The inventory quantity calculation system of claim 11, wherein the decision value is of a Relative Strength Index (RSI) of the plurality of historical estimated shipment quantities.

13. The inventory quantity calculation system of claim 11, wherein the decision value is of a stochastic oscillator (KD indicator) of the plurality of historical estimated shipment quantities.

14. The inventory quantity calculation system of claim 11, wherein the decision value is of a moving average convergence/divergence (MACD) indicator of the plurality of historical estimated shipment quantities.

15. The inventory quantity calculation system of claim 11, wherein the display unit is a non-self-emissive display or a self-emissive display.

16. The inventory quantity calculation system of claim 11, wherein the plurality of historical beginning-of-period stock quantity estimates, the plurality of historical end-of-period stock quantity estimates, the plurality of historical end-of-period actual stock quantities, and the plurality of historical estimated shipment quantities are stored in a cloud system.

17. The inventory quantity calculation system of claim 16, further comprising a network unit, wherein the receiving unit receives the plurality of historical beginning-of-period stock quantity estimates, the plurality of historical end-of-period stock quantity estimates, the plurality of historical end-of-period actual stock quantities, and the plurality of historical estimated shipment quantities from the cloud system through the network unit.

18. The inventory quantity calculation system of claim 11, wherein the calculation unit calculates the first stock quantity estimate through an experience model.

19. The inventory quantity calculation system of claim 11, wherein the calculation unit calculates the second stock quantity estimate through an adaptive weight assignment model.

20. The inventory quantity calculation system of claim 11, wherein the third stock quantity estimate is obtained by interpolating the first stock quantity estimate and the second stock quantity estimate.
